(19) United States
(12) Patent Application Publication
(10) Pub. No.: US 2008/0244636 A1
(43) Pub. Date: Oct. 2, 2008

(54) SYSTEM AND METHOD FOR FILTERING MEDIA PRODUCTS BASED ON MEDIA PRODUCT INFORMATION

(75) Inventor: John A. Card, Lakewood, CO (US)

Correspondence Address: SETTER ROCHE LLP, PO BOX 780, ERIE, CO, 80516, US

(73) Assignee: EchoStar Satellite LLC, Englewood, CO (US)

(21) Appl. No.: 11/693,065

(22) Filed: Mar. 29, 2007

(51) Int. Cl. G06F 3/038

(52) U.S. Cl. 725/25; 725/45

(57) ABSTRACT

A media control system receives first product information that describes a first media product and receives second product information that describes a second media product. The media control system processes the first product information with a filter to determine if the first media product should be blocked. The media control system selects data from the first product information and modifies the filter based on the data. The media control system processes the second product information with the modified filter to determine if the second media product should be blocked and blocks the second media product based on the modified filter.

### BACKGROUND

Media distribution systems transfer media products, such as movies, television programs, music, and pictures to user systems that present the media products to their users. Over the last several decades, the amount of media products has increased on a massive scale. In addition, the media distribution systems typically provide the products over broadcast channels, and the user selects the broadcast channel that is presenting their desired media product. The number of these broadcast channels has also increased dramatically. Thus, the typical user has a daily selection of thousands of different media products that are provided over hundreds of different broadcast channels.

In addition to the sheer quantity of media products and broadcast channels, the content of media products has diversified across a wide spectrum that includes content for children and content for adults. The adult content may include graphic violence, sexual content, drug use, and profane language. Many users do not want media products with adult content to be presented by their media system. For example, a parent may not want a movie with graphic violence to be displayed to their children. The parent may not want their children to listen to music that is laced with profanity. In response, the media distribution systems have implemented filters to allow users to block certain types of media products from being presented by their systems.

These filters are largely based on ratings and content descriptors for the media products. The ratings may be the well-known G, PG, R, and X ratings. The content descriptors may indicate whether a media product has graphic violence, profane language, sexual content, drug use, or some other type of content. To block a media product, the user manually configures their filter to block media products based on ratings or content descriptors. For example, a parent may configure their system to block any media product with an R or X rating, or block any media product with a graphic violence content descriptor. In addition, the user may manually configure their filter to block an entire broadcast channel.

Unfortunately, many users disagree with the ratings and content descriptors that are given to a media product. For example, an R rated movie may be edited, so the edited version has a PG rating, but the movie may still be objectionable to the user. In another example, a television program may be filled with sexual innuendo, but not have a content descriptor for sexual content. Over time, the media industry has modified how these ratings and descriptors are applied to media products. For example, a movie that was rated R ten years ago may now receive a PG rating. As a result, users cannot fully rely on inconsistent and changing ratings and content descriptors to properly filter out undesired media products.

The problem posed by inconsistent and changing ratings and content descriptors is exacerbated by the sheer number of media products and broadcast channels. Many users are simply overwhelmed by the volume of media products and channels coupled with the wide diversity of media content. Given the inconsistent and changing ratings and content descriptors, the user cannot effectively filter out the media products that they want to block.

Further aggravating this situation is the need for the user to manually configure their filter. To establish or modify the filter, the user has to manually operate their system to set the filter criteria. This manual configuration is too complex or cumbersome for many users. Given such a diversified set of media products, broadcast channels, and inconsistent ratings, the continuous manual reconfiguration becomes a chore to the user. Many users may not have the time to configure their filter to their satisfaction.

### BRIEF DESCRIPTION OF THE DRAWINGS

FIG. 1 illustrates a media distribution system in an embodiment of the invention.

FIG. 2 illustrates a media control system in an embodiment of the invention.

FIG. 3 illustrates the operation of a media control system in an embodiment of the invention.

FIG. 4 illustrates a filter establishment display in an embodiment of the invention.

FIG. 5 illustrates a filter enhancement display in an embodiment of the invention.

FIG. 6 illustrates a media control system in an embodiment of the invention.

### DETAILED DESCRIPTION

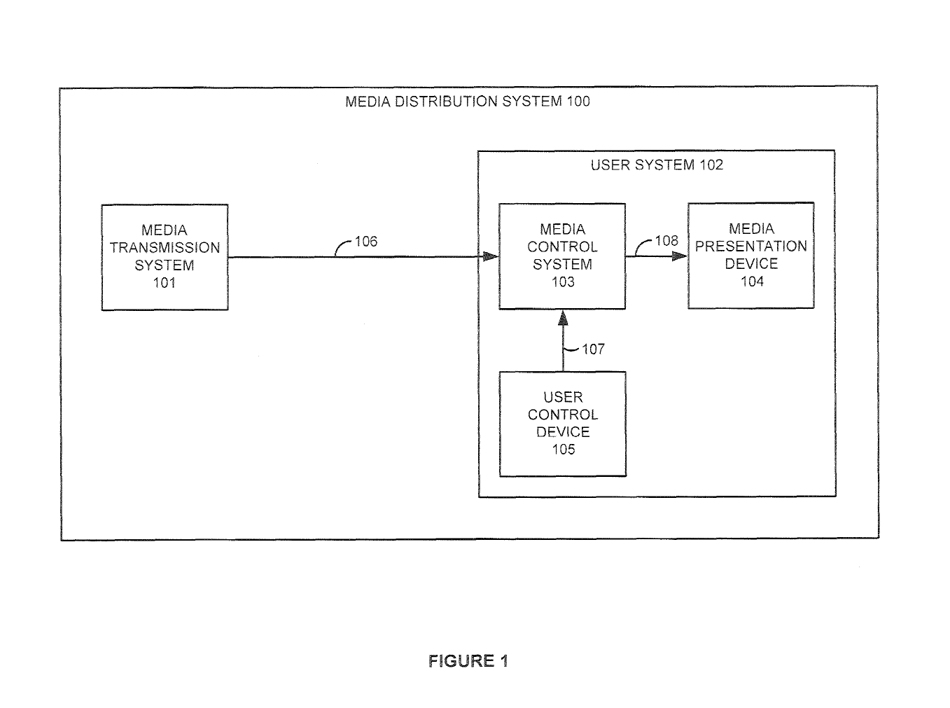

FIG. 1 illustrates media distribution system 100 in an embodiment of the invention. Media distribution system 100 comprises media transmission system 101 and user system 102. Only a single user system 102 is shown for clarity, but there could be millions of other user systems that are configured like user system 102. User system 102 includes media control system 103, media presentation device 104, and user control device 105.

Media transmission system 101 transfers media signal 106 to media control system 103 at user system 102. Media signal 106 carries media products and product information for the media products. Media transmission system 101 may transfer media signal 106 to user system 102 over a satellite link, metallic link, optical link, wireless link, or some other type of communication link—including combinations of different communication links. In this embodiment, the media products and the product information are transported together in media signal 106, but in other embodiments (discussed further below), the media products and the product information may be transported separately to the media control system.

Media control system 103 receives media signal 106 from media transmission system 101. Media control system 103 also receives user control signal 107 from user control device 105. Media control system 103 processes signals 106-107 to transfer media signal 108 to media presentation device 104. Media control system 103 could be a satellite receiver, cable receiver, Internet appliance, computer, or some other media control apparatus.

Media presentation device 104 receives media signal 108 from media control system 103. Media signal 108 includes media products and control information. The control information may include product information for the media products. Media presentation device 104 presents the media products and control information to the user. For example, media device 104 may display video, play audio, or display and play a combined video/audio product to the user. Likewise, media device 104 may display control information, play the control information, or display and play the control information to the user. Other techniques to present media products and control information to a user could be used. Media device 104 could be a television, music player, computer monitor, display screen, audio system, or some other user media apparatus.

User control device 105 receives control inputs from the user, typically in response to the media products and control information presented by media device 104. User control device 105 processes the user control inputs to transfer user control signal 107 to media control system 103. User control device 105 could be a handheld remote control, keyboard, touch screen, or some other user interface.

Note that media control system 103, media presentation device 104, and user control device 105 could be integrated into a single device or distributed among multiple devices. In addition, some functions of media control system 103, media presentation device 104, and user control device 105 may be integrated together while other functions remain distributed.

The media products could be movies, music, television programs, audio books, pictures, media clips, live media feeds, or some other media content. Each media product has its own related product information. The product information may include a title, rating, content descriptors, content summary, actors, director, production entity, musician, show time, and broadcast channel. This product information is exemplary, and a media product may have other product information.

For a given media product, media control system 103 processes its product information with a filter to determine whether the media product may be presented by media presentation device 104 or whether the media product should be blocked from presentation by media presentation device 104. Media control system 103 may apply the filter to all media products in media signal 106, a subset of the media products in media signal 106, or only to the media products in media signal 106 that are selected by the user for presentation. The filter may be established by the user through user control device 105, be pre-configured within media control system 103, or be transferred to media control system 103 by an external entity. In addition, some aspects of the filter may be established by the user, while some other aspects are pre-configured, and yet other aspects are transferred into system 103 from an external entity.

Advantageously, media control system 103 may be configured to automatically enhance the filter based on the product information for blocked media products. In addition, media control system 103 may be configured, upon a user request, to display product information for a media product currently being presented. The user may then conveniently enhance their filter by selecting specific product information. Thus, the user may configure their filter to automatically build itself with detailed product information from objectionable media products. The user may also enhance the filter themselves with detailed product information from the media product that is currently being presented. The resulting filter is far more robust and detailed than prior filters while being easier for the user to configure.

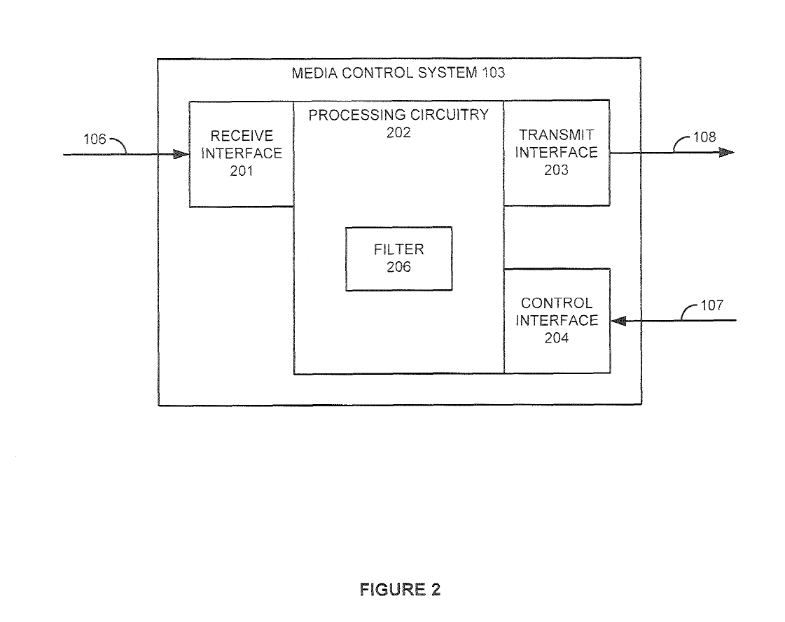

FIG. 2 illustrates media control system 103 in an embodiment of the invention. Media control system 103 comprises receive interface 201, processing circuitry 202, transmit interface 203, and control interface 204. Processing circuitry 202 includes filter 206.

Receive interface 201 comprises communication components that receive and transfer media signal 106 to processing circuitry 202. Control interface comprises communication components that receive and transfer user control signal 107 to processing circuitry 202. Processing circuitry 202 processes signals 106-107 to transfer media signal 108 to transmit interface 203. Transmit interface 203 comprises communication components that receive and transfer media signal 108. To interact with the user through control interface 204, processing circuitry 202 includes various control information in media signal 108 for presentation to the user.

Processing circuitry 202 includes filter 206 to block specific media products from inclusion in media signal 108. Processing circuitry 202 processes product information to automatically modify filter 206. Processing circuitry 202 also processes control signal 107 and the product information to modify filter 206.

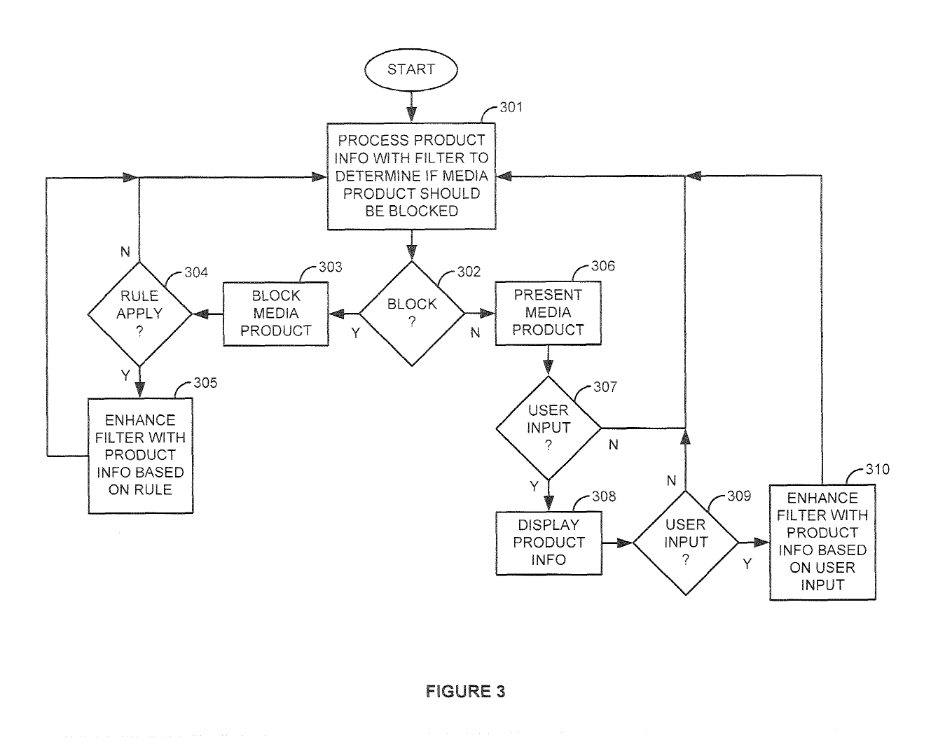

FIG. 3 illustrates the operation of media control system 103 in an embodiment of the invention. The reference numbers from FIG. 3 are indicated parenthetically below. Before the operation begins, the filter and automatic filter enhancement rule set have been established. This could be accomplished by the user, by pre-configuring media control system 103, or by transferring filter components to system 103.

For a first media product, media control system 103 processes product information with the filter to determine if the first media product should be blocked (301). If the media product should be blocked (302), then media control system 103 blocks the media product (303) and determines if any automatic filter enhancement rule applies (304). If a rule applies (304), media control system 103 automatically enhances the filter with the product information based on the rule (305). If no rule applies (304) or after automatic filter enhancement (305), the operation returns to process 301.

If the first media product should not be blocked (302), then media control system 103 transfers the media product for presentation to the user (306). During the presentation, if media control system 103 receives a user input to enhance the filter (307), then media control system 103 transfers product information for the current media product for display of the product information (308). If media control system 103 receives a user input selecting product information (309), media control system 103 enhances the filter with the selected product information based on the user input (310). If there are no user inputs to enhance the filter (307, 309) or after user-selected filter enhancement (310), the operation returns to process 301.

For a second media product, media control system 103 processes product information with the filter to determine if the media product should be blocked (301). Note that any filter enhancements made for the first media product (305, 310) would apply, so if the second media product should be blocked (302) based on the enhanced filter, then media control system 103 blocks the second media product (303).

If desired, media control system 103 could record each automatic filter enhancement (305) along with the time and the reason that the enhancement was made. Media control system 103 could then display the automatic enhancements and background information to the user at their convenience. The user may then decide whether to keep the automatic enhancement or whether to delete the automatic enhancement. If the user chooses to delete the automatic enhancement, then media control system 103 would restore the filter to its configuration before the automatic enhancement was made.

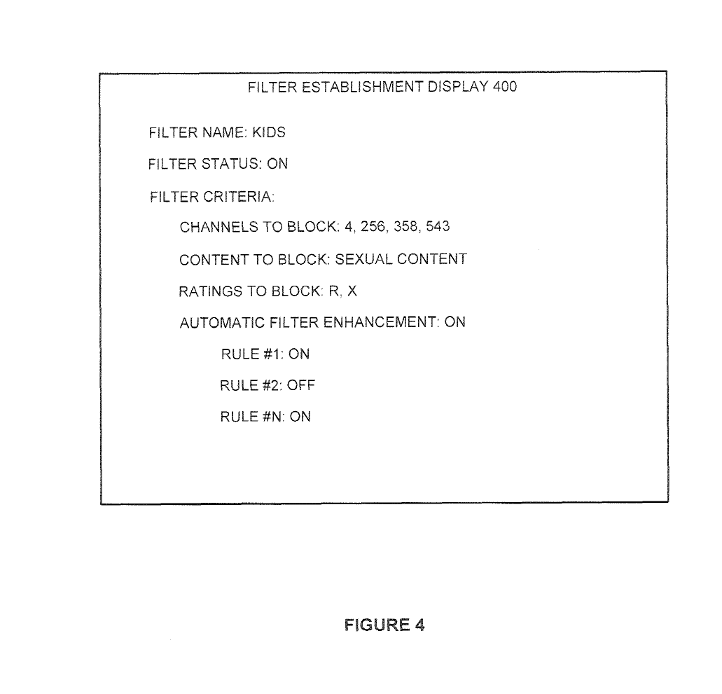

FIG. 4 illustrates filter establishment display 400 in an embodiment of the invention. Note that display 400 is intended to teach inventive principles, and does not represent all aspects of a typical control display. Nor does display 400 represent an exhaustive list of possible filter criteria. In addition, various Graphical User Interface (GUI) techniques may be used, such as drop-down boxes and selection buttons. Display 400 has been simplified for clarity, and does not represent all possible GUI techniques that could be used. Only one filter is discussed below, but multiple different filters may be established by the user in a similar fashion.

Media control system 103 would provide filter establishment display 400 during a service set-up procedure or in response to a user request. Display 400 allows the user to name the filter and to turn the filter on and off. The user may assign time frames to different filters, so one filter may be on during the day and another filter may be on at night.

Filter establishment display 400 allows the user to specify which channels to block, such as channels 4, 256, 358, and 543. Filter establishment display 400 allows the user to specify which content descriptors to block, such as sexual content. Filter establishment display 400 allows the user to specify which ratings to block, such as R and X ratings.

Filter establishment display 400 allows the user to turn automatic filter enhancement on and off. Filter establishment display 400 allows the user to specify which automatic enhancement rules should be applied and which rules should not be applied. For example, rule #1 could be to automatically block a channel if that channel shows a media product with a blocked content descriptor, such as sexual content. Rule#2 could be to automatically block a title if the title is blocked due to a rating, such as an R or X rating. The user has turned rule #1 on and rule #2 off.

Thus, filter establishment display 400 allows the user to set general filter criteria and to set automatic filter enhancement rules. As indicated above, media control system 103 uses the general criteria to block media products and uses the rules to automatically enhance the filter based on the product information from blocked media products. Subsequently, media control system 103 blocks media products based on the automatically selected product information.

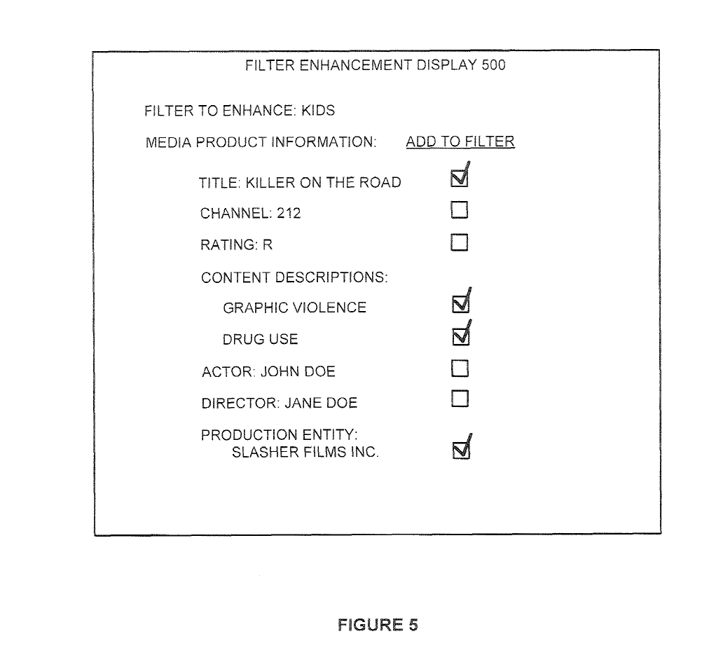

FIG. 5 illustrates filter enhancement display 500 in an embodiment of the invention. Note that display 500 is intended to teach inventive principles, and does not represent all aspects of a typical control display. Nor does display 500 represent an exhaustive list of possible filter criteria. In addition, various GUI techniques may be used, such as drop-down boxes and selection buttons. Display 500 has been simplified for clarity, and does not represent all possible GUI techniques that could be used. Multiple different filters may be enhanced by the user in a similar fashion.

Media control system 103 would provide filter enhancement display 500 in response to a user request. Display 500 includes the product data for the media product currently being presented. Note that display 500 could also be provided where the user is viewing a programming guide with the media product selected. Display 500 allows the user to select the filter to enhance and to add specific product information to the filter.

Filter enhancement display 500 allows the user to block subsequent media products having the title of the current media product. Filter enhancement display 500 allows the user to block the channel that is presenting the current media product. Filter enhancement display 500 allows the user to block subsequent media products having the rating of the current media product. Filter enhancement display 500 allows the user to block subsequent media products having the content descriptors for the current media product. Filter enhancement display 500 allows the user to block subsequent media products having the actors, directors, and production entity for the current media product. Filter enhancement display 500 could also allow the user to block subsequent media products having the musician (not shown) for the current media product.

In this example, the user has added the title, content descriptors, and production entity for the current media product to the filter. Thus, media control system 103 would subsequently block any media products having the title of “Killer on the Road.” Media control system 103 would subsequently block any media products having content descriptors for graphic violence or drug use. Media control system 103 would subsequently block any media products from the production entity of Slasher Films, Inc. Note that the user was able to easily add detailed filter criteria to their filter.

Advantageously, the filter may be conveniently configured by the user to block a media product based on a robust and detailed set of product information. For example, the filter may block media products based on title, rating, content descriptors, content summary, actors, musicians, director, production entity, show time, broadcast channel, or some other product information. The filter is automatically enhanced based on product information and a user-controlled rule set. For convenience, the user may select product information to add to the filter while viewing or listening to a media product.

For example, consider that a user is viewing a movie and decides to enhance their filter. The user operates their control device to display the product information for the movie and to select a content descriptor for the movie, such as sexual content, for addition to the filter. Subsequently, media control system 103 blocks any media products having that content descriptor.

In another example, consider that a user is viewing a movie and decides to enhance their filter. The user operates their control device to display the product information for the movie and to select a channel showing the movie for addition to the filter. Subsequently, media control system 103 blocks the channel.

In another example, consider that a user is viewing a movie and decides to enhance their filter. The user operates their control device to display the product information for the movie and to select an actor, director, or production entity for the movie for addition to the filter. Subsequently, media control system 103 blocks any media products having that actor, director, or production entity.

In another example, consider that a user is listening to a song and decides to enhance their filter. The user operates their control device to display the product information for the song and to select the musician for addition to the filter. Subsequently, media control system 103 blocks any media products having that musician.

Advantageously, media control system 103 may automatically enhance the filter based on the product information and a user-controlled rule set. One rule could be to automatically block any media product having the same title as a media product that is blocked for another reason. For example, the user could configure the filter to block R rated media products and to have a rule to automatically add the titles of any blocked media products to the filter, so that media products with the same title are blocked regardless of rating. Thus, even if a media product is edited to reduce its rating from R to PG, the filter would automatically block the PG version as well.

Another rule could be to automatically block any channel presenting a media product having a given content descriptor or rating. For example, the user could configure the filter to automatically block any channel that shows a media product having a nudity content descriptor. Thus, once a channel shows a single media product having a nudity content descriptor, the filter would automatically block that channel. In another example, the user could configure the filter to automatically block any channel that plays a media product having an X or R rating. Thus, once a channel plays an X or R rated media product, the filter would automatically block that channel.

In some embodiments, media distribution system 100 comprises a broadcast satellite media distribution system where satellites in earth orbit broadcast media signals to satellite receiver systems at user sites. The satellite receiver systems drive user media displays or audio systems and could implement the media control described herein. Other media distribution systems could also implement this media control, including but not limited to, cable television systems, terrestrial broadcast television systems, and Internet-based media systems.

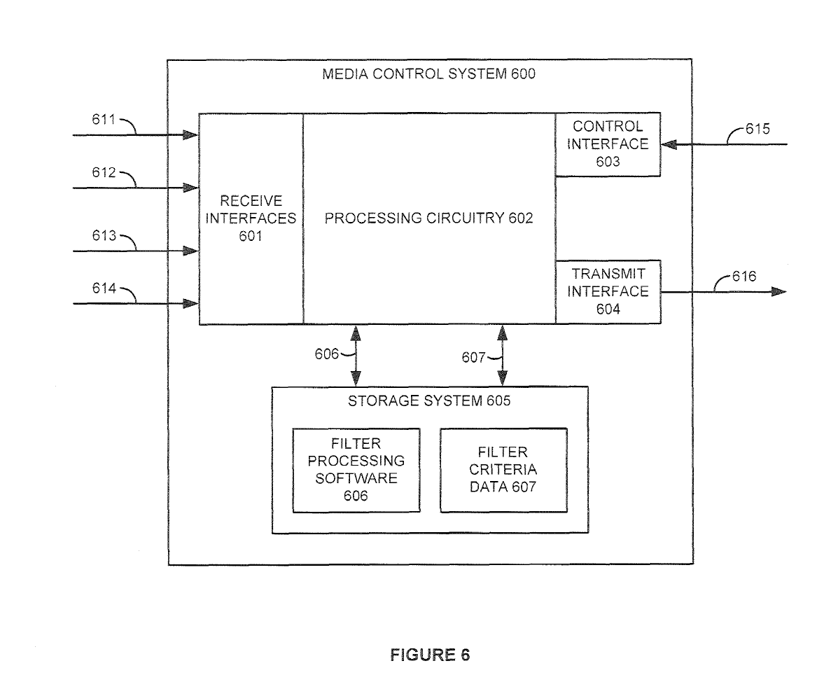

FIG. 6 illustrates media control system 600 in an embodiment of the invention. Media control system 600 comprises receive interfaces 601, processing circuitry 602, control interface 603, transmit interface 604, and storage system 605. Storage system 605 comprises a storage device, such as memory circuitry or a memory drive, that stores filter processing software 606 and filter criteria data 607.

Media control system 600 is configured and operates to filter media products as described above for media control system 103. Media control system 600 is also configured and operates as described above for media control system 103 to modify the filter—either automatically or through user inputs. Media control system 600 includes some additional aspects that are described below.

Receive interfaces 601 comprise communication components that receive and transfer signals 611-614 to processing circuitry 602. Signal 611 carries media products. Signal 612 carries product information for the media products. Signal 613 carries filter processing software. Signal 614 carries filter criteria data. Signals 611-614 could be transferred from one system or from multiple different systems. Signals 611-614 could be transferred over the same communication link or over multiple different communication links.

Control interface 603 comprises communication components that receive and transfer user control signal 615 to processing circuitry 602. Processing circuitry 602 transfers a media signal 616 to transmit interface 604. Transmit interface 604 comprises communication components that receive and transfer media signal 616 to a media presentation device. To interact with the user through control interface 603, processing circuitry 602 includes various control information in media signal 616 for presentation to the user.

Processing circuitry 602 retrieves and processes filter processing software 606 and filter criteria data 607 to filter specific media products from inclusion in media signal 616. Filter processing software 606 directs the general operation of this filter. Filter criteria data 607 comprises the specific data that is used to block media products, such as content descriptors, ratings, titles, musicians, or some other data.

Processing circuitry 602 modifies the filter by modifying filter processing software 606 and filter criteria data 607. In this embodiment, processing circuitry 602 receives and processes filter processing software from signal 613 to load or modify filter processing software 606 in storage system 605. For example, processing circuitry 602 may receive a software version update in signal 613 and load the new version of software 606 in storage system 605. In addition, processing circuitry 602 receives and processes filter criteria data from signal 614 to load or modify filter criteria data 607 in storage system 605. For example, processing circuitry 602 may receive a new filter criteria data in signal 614 and load the new filter criteria data 607 in storage system 605.

Although specific embodiments of the invention have been discussed herein, other embodiments encompassed by the scope of the invention are possible. Also, aspects of one embodiment may be combined with those of alternative embodiments to create further implementations of the present invention. Thus, while the present invention has been described in the context of specific embodiments, such descriptions are provided for illustration and not limitation. Accordingly, the proper scope of the present invention is delimited only by the following claims.

What is claimed is:

1. A method of operating a media control system, the method comprising:
receiving first product information that describes a first media product;
processing the first product information with a filter to determine if the first media product should be blocked;
selecting data from the first product information and modifying the filter based on the data;
receiving second product information that describes a second media product;
processing the second product information with the modified filter to determine if the second media product should be blocked; and
blocking the second media product based on the modified filter.

2. The method of claim 1 further comprising blocking the first media product based on the filter, and wherein selecting the data from the first product information comprises automatically selecting the data in response to blocking the first media product.

3. The method of claim 2 wherein selecting the data from the first product information comprises selecting a title of the first media product, wherein modifying the filter comprises modifying the filter to block other media products having the title, and wherein the second media product has the title.

4. The method of claim 2 wherein selecting the data from the first product information comprises selecting a channel presenting the first media product, wherein modifying the filter comprises modifying the filter to block the channel, and wherein the channel is presenting the second media product.

5. The method of claim 1 further comprising:
receiving a first user input, and in response, driving a display of the first product information; and
receiving a second user input identifying the data from the first product information and wherein selecting the data from the first product information comprises selecting the data based on the second user input.

6. The method of claim 5 wherein the data selected from the first product information comprises a title of the first media product, wherein modifying the filter comprises modifying the filter to block other media products having the title, and wherein the second media product has the title.

7. The method of claim 5 wherein the data selected from the first product information comprises a content descriptor for the first media product, wherein modifying the filter comprises modifying the filter to block other media products with the content descriptor, and wherein the second media product has the content descriptor.

8. The method of claim 5 wherein the data selected from the first product information comprises a channel presenting the first media product, wherein modifying the filter comprises modifying the filter to block the channel, and wherein the channel is presenting the second media product.

9. The method of claim 5 wherein the data selected from the first product information comprises one of an actor, director, and production company for the first media product, wherein modifying the filter comprises modifying the filter to block other media products with the selected one of the actor, the director, and the production entity, and wherein the second media product has the selected one of the actor, the director, and the production company.

10. A method of operating a media control system, the method comprising:
receiving first product information that describes a first media product;
processing the first product information with a filter to determine if the first media product should be blocked and blocking the first media product based on the filter;
automatically selecting data from the first product information in response to blocking the first media product and automatically modifying the filter based on the data selected from the first product information;
receiving second product information that describes a second media product;
processing the second product information with the modified filter to determine if the second media product should be blocked and blocking the second media product based on the modified filter;
receiving third product information that describes a third media product;
receiving a first user input, and in response, driving a display of the third product information;
receiving a second user input identifying data from the third product information; and
modifying the modified filter in response to the second user input based on the data identified from the third product information.

11. A media control system comprising:
a receive interface configured to receive first product information that describes a first media product and receive second product information that describes a second media product; and
processing circuitry configured to process the first product information with a filter to determine if the first media product should be blocked, select data from the first product information, modify the filter based on the data, process the second product information with the modified filter to determine if the second media product should be blocked, and block the second media product based on the modified filter.

12. The media control system of claim 11 wherein the processing circuitry is configured to block the first media product based on the filter and to automatically select the data from the first product information in response to blocking the first media product.

13. The media control system of claim 12 wherein the processing circuitry is configured to automatically select a title of the first media product and modify the filter to block other media products having the title, and wherein the second media product has the title.

14. The media control system of claim 12 wherein the processing circuitry is configured to automatically select a channel presenting the first media product and modify the filter to block the channel, and wherein the channel is presenting the second media product.

15. The media control system of claim 11 further comprising:
a control interface configured to receive a first user input and to receive a second user input identifying the data selected from the first product information; and
wherein the processing circuitry is configured to drive a display of the first product information in response to the first user input and to select the data identified from the first product information based on the second user input.

16. The media control system of claim 15 wherein the second user input identifies a title of the first media product, wherein the processing circuitry is configured to modify the filter to block other media products having the title, and wherein the second media product has the title.

17. The media control system of claim 15 wherein the second user input identifies a content descriptor for the first media product, wherein the processing circuitry is configured to modify the filter to block other media products with the content descriptor, and wherein the second media product has the content descriptor.

18. The media control system of claim 15 wherein the second user input identifies a channel presenting the first media product, wherein the processing circuitry is configured to modify the filter to block the channel, and wherein the channel is presenting the second media product.

19. The media control system of claim 15 wherein the second user input identifies one of an actor, director, and production company for the first media product, wherein the processing circuitry is configured to modify the filter to block other media products with the one of the actor, the director, and the production entity, and wherein the second media product has the one of the actor, the director, and the production company.

20. The media control system of claim 11 wherein the receive interface comprises a satellite receiver.
